(19) United States
(12) Patent Application Publication
(10) Pub. No.: US 2014/0223382 A1
(43) Pub. Date: Aug. 7, 2014

(54) Z-SHAPED GESTURE FOR TOUCH SENSITIVE UI UNDO, DELETE, AND CLEAR FUNCTIONS

(71) Applicant: BARNESANDNOBLE.COM LLC, New York, NY (US)

(72) Inventors: Kourtny M. Hicks, Sunnyvale, CA (US); Dale J. Brewer, San Marco, CA (US)

(73) Assignee: barnesandnoble.com llc, New York, NY (US)

(21) Appl. No.: 13/757,378

(22) Filed: Feb. 1, 2013

(51) Int. Cl. G06F 3/01

(52) U.S. Cl. CPC G06F 3/017
USPC 715/863

(57) ABSTRACT

Techniques are disclosed for providing a Z-shaped gesture mode in electronic touch sensitive devices. In some cases, the Z-shaped gesture mode may be configured to undo an action or delete or clear content when a Z-shaped gesture is made. The Z-shaped gesture mode may also be configured to allow the reversal of previously performed undo, delete, and clear functions using a Z-shaped gesture. In some instances, the undo, delete, and clear functions are performed by a Z-shaped gesture drawn from top to bottom, and the reverse function is performed by a reverse Z-shaped gesture drawn from bottom to top. In some cases, the starting contact point and/or ending contact point of the Z-shaped gesture may control the function performed. In some configurations, the Z-shaped gesture mode may include a gesture and hold feature that is activated by holding the ending contact point of the Z-shaped gesture.

### FIELD OF THE DISCLOSURE

This disclosure relates to electronic display devices, and more particularly, to user interface techniques for interacting with touch sensitive devices.

### BACKGROUND

Electronic display devices such as tablets, eReaders, mobile phones, smart phones, personal digital assistants (PDAs), and other such touch screen electronic display devices are commonly used for displaying consumable content. The content may be, for example, an eBook, an online article or blog, images, a movie or video, a map, just to name a few types. Such display devices are also useful for displaying a user interface that allows a user to interact with one or more applications or services running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1a-b illustrate an example electronic touch sensitive device configured with a Z-shaped gesture mode in accordance with an embodiment of the present invention.

FIGS. 1c-d illustrate example configuration screen shots of the user interface of the electronic touch sensitive device shown in FIGS. 1a-b configured in accordance with an embodiment of the present invention.

FIG. 2a illustrates a block diagram of an electronic touch sensitive device configured in accordance with an embodiment of the present invention.

FIG. 2b illustrates a block diagram of a communication system including the electronic touch sensitive device of FIG. 2b configured in accordance with an embodiment of the present invention.

FIGS. 3a-i show screen shots of example Z-shaped gestures that can be applied to a touch sensitive surface of an electronic device and corresponding functions for a Z-shaped gesture mode, in accordance with one or more embodiments of the present invention.

FIGS. 4a-d show screen shots of a Z-shaped gesture mode configured with a gesture and hold feature, in accordance with an embodiment of the present invention.

FIG. 5 illustrates a method for providing a Z-shaped gesture mode in an electronic touch sensitive device, in accordance with an embodiment of the present invention.

### DETAILED DESCRIPTION

Techniques are disclosed for providing a Z-shaped gesture mode in electronic touch sensitive devices. The Z-shaped gesture mode may be configured, for example, to undo an action, or to delete or clear content when a Z-shaped gesture is made. The Z-shaped gesture mode may also be configured to allow the reversal of previously performed undo, delete, and clear functions using a reverse Z-shaped gesture. For instance, the undo, delete, and clear functions can be performed by a Z-shaped gesture drawn top-to-bottom and the reverse function can be performed by a reverse Z-shaped gesture drawn bottom-to-top. In some cases, the starting contact point and/or ending contact point of the Z-shaped gesture may control the function performed. In some configurations, the Z-shaped gesture mode may include a gesture and hold feature that is activated by holding the ending contact point of the Z-shaped gesture. Numerous other configurations and variations will be apparent in light of this disclosure.

General Overview

As previously explained, electronic display devices such as tablets, eReaders, and smart phones are commonly used for displaying user interfaces and consumable content. In some instances, the user may desire to undo an action that was previously performed or to delete/clear specific content. For example, when interacting with input boxes, such as text boxes, a user may desire to undo the most recent entry, delete a particular section, or clear the input box entirely. While some electronic devices provide methods for undoing an action and deleting/clearing content, they typically require the user to physically shake the device or to press/select a control button. These methods may not always be intuitive and therefore may lead to a diminished user experience.

Thus, and in accordance with an embodiment of the present invention, techniques are disclosed for using a Z-shaped gesture mode to perform undo, delete, and clear functions in electronic touch sensitive devices. As will be apparent in light of this disclosure, the Z-shaped gesture mode provides a simple and intuitive gesture for performing these functions. In particular, a Z-shaped gesture nicely relates to an undo function since the control-z keystroke is commonly used for the undo command (e.g., in applications such as Microsoft® Windows®). Further, a Z-shaped gesture nicely relates to undo, delete, and clear functions since it is comparable to an erasing or scratching-out motion. It follows then, that is it is also intuitive to use a reverse Z-shaped gesture (i.e., drawn from bottom-right to top-left) to reverse one or more previously performed Z-based undo, delete, and/or clear functions, since this technique prevents a user from having to learn another gesture shape and provides a quick and easy way to reverse the previously performed function. This reversal concept may be applied to any gesture-based function.

As disclosed herein, some embodiments of the Z-shaped gesture mode may be configured such that a Z-shaped gesture (from the top-left to the bottom-right of the Z-shape) performs an undo, delete, or clear function. Further, in some embodiments, the Z-shaped gesture mode may be configured such that a reverse-drawn Z-shaped gesture (from the bottom-right to the top-left of the Z-shape) performs a reverse function that reverses one or more previously performed undo, delete, or clear functions. As will be appreciated, the Z-shape need not be perfectly drawn or symmetrical. In some example cases, the Z-shaped gesture mode may be configured such that different characteristics of the Z-shaped gesture effectively control the function performed, such as the location, size, speed, and number of starting contact points used (e.g., number of fingers used to draw the Z-shaped gesture). For example, in some scenarios, a single point Z-shaped gesture may delete the specific content over which the gesture is made/drawn. In other example case, a single point Z-shaped gesture may clear a data entry field through which at least a portion of that gesture passes (e.g., starting point, middle point, or end point of gesture). In another example case, a two point reverse Z-shaped gesture may reverse the last two actions performed, or a five point reverse Z-shaped gesture may reverse the last five actions performed, etc. In another example case, a fastly drawn Z-shape gesture drawn in a relatively arbitrary fashion in the middle of a content block or field (e.g., paragraph, email body, paint canvas/screen, note screen, etc) may delete that block or clear that field or undo that last action that occurred in that field (e.g., undue typing of a word or sentence), while a relatively slower and deliberately drawn Z-gesture will only delete or clear the content between the start and stop points of the gesture.

Note for Z-based deletion and clear actions that the start and stop points of the Z-shape can correspond to the start and stop points of the content to be deleted/cleared, whether that content be a block of text or rich media, one or more folders, one or more files, a portion of an image or one or more complete images from a picture album or video sequence, a series of images within a video, or a document or group of documents. Further note that the actual Z-shape may vary depending on the shape of the content block to be deleted (e.g., the top horizontal bar of the Z may be shorter or longer than the bottom horizontal bar of the Z).

In some embodiments, the Z-shaped gesture mode may be configured such that when the ending contact point is held after making the Z-shaped gesture (referred to herein as a Z-shaped gesture and hold or a gesture and hold feature) a desired action occurs. For example, after a Z-shaped gesture and hold, a pop-up menu may appear presenting selectable function options (such as undo last, undo last five, and undo all). In some instances, the duration that the ending contact point is held before being released may determine the function performed. For example, the mode may be configured such that holding for a first duration undoes the last action, holding for a second duration undoes the last two actions, holding for a third duration undoes the last five actions, etc.

In some embodiments, the functions performed when using a Z-shaped gesture mode described herein may be configured at a global level (i.e., based on the UI settings of the electronic device) and/or at an application level (i.e., based on the specific application being displayed). To this end, the Z-shaped gesture mode may be user-configurable in some cases, or hard-coded in other cases.

Numerous Z-shaped gesture mode applications and Z-shaped gesture schemes will be apparent in light of this disclosure. The Z-shaped gestures referred to herein are not limited to an exact Z-shape, and should thus be understood to include Z-shape variations. Therefore, the Z-shaped gesture mode may be configured to detect Z-shape variations within a certain range to account for deviation when the gesture is being drawn. Additionally, the Z-shaped gestures are not intended to be limited to one continuous gesture, unless expressly stated. For instance, rather than one continuous gesture, the Z-shape may be made with three separate line-based gestures that collectively form a Z-shape, or with two separate gestures including a 7-shape gesture and a line-based gesture. Further note that any touch sensitive device (e.g., track pad, touch screen, or other touch sensitive surface, whether capacitive, resistive, acoustic or other touch detecting technology, regardless of whether a user is physically contacting the device or using some sort of implement, such as a stylus) may be used to detect user input when making the Z-shaped gestures described herein, and the claimed invention is not intended to be limited to any particular type of touch sensitive technology. For ease of reference, user input is sometimes referred to as contact or user contact; however, direct and/or proximate contact (e.g., hovering within a few centimeters of the touch sensitive surface) can be used to make the Z-shaped gestures described herein. In other words, in some embodiments, a user can use the Z-shaped gesture mode without physically touching the touch sensitive device.

Architecture

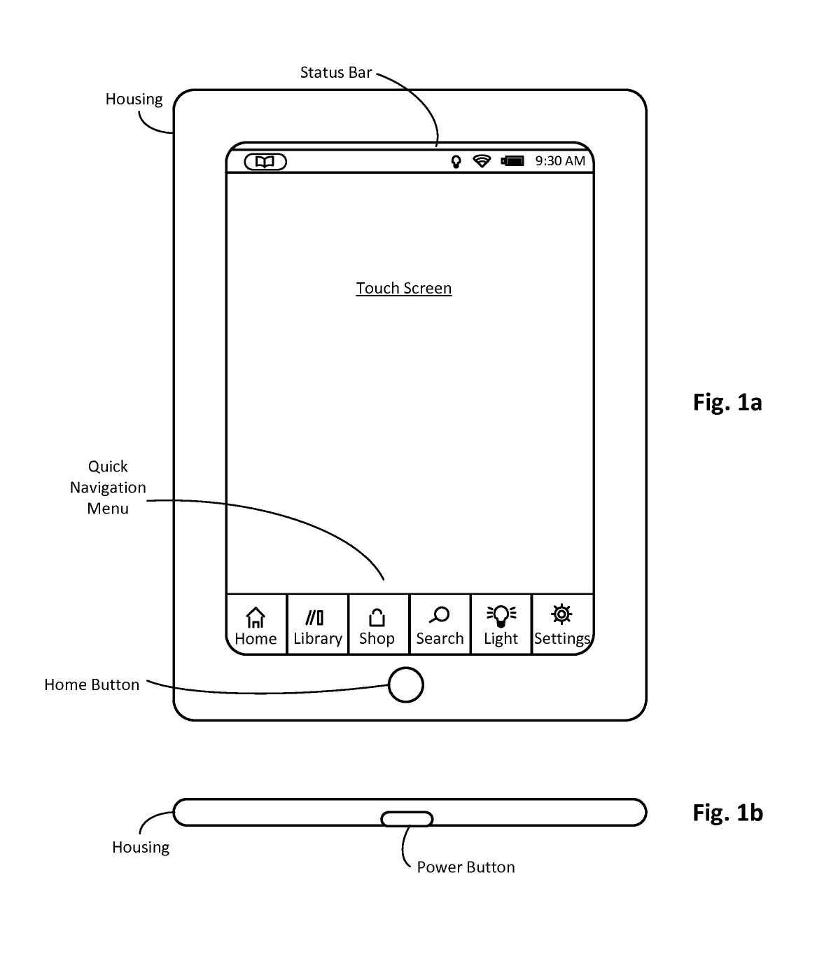

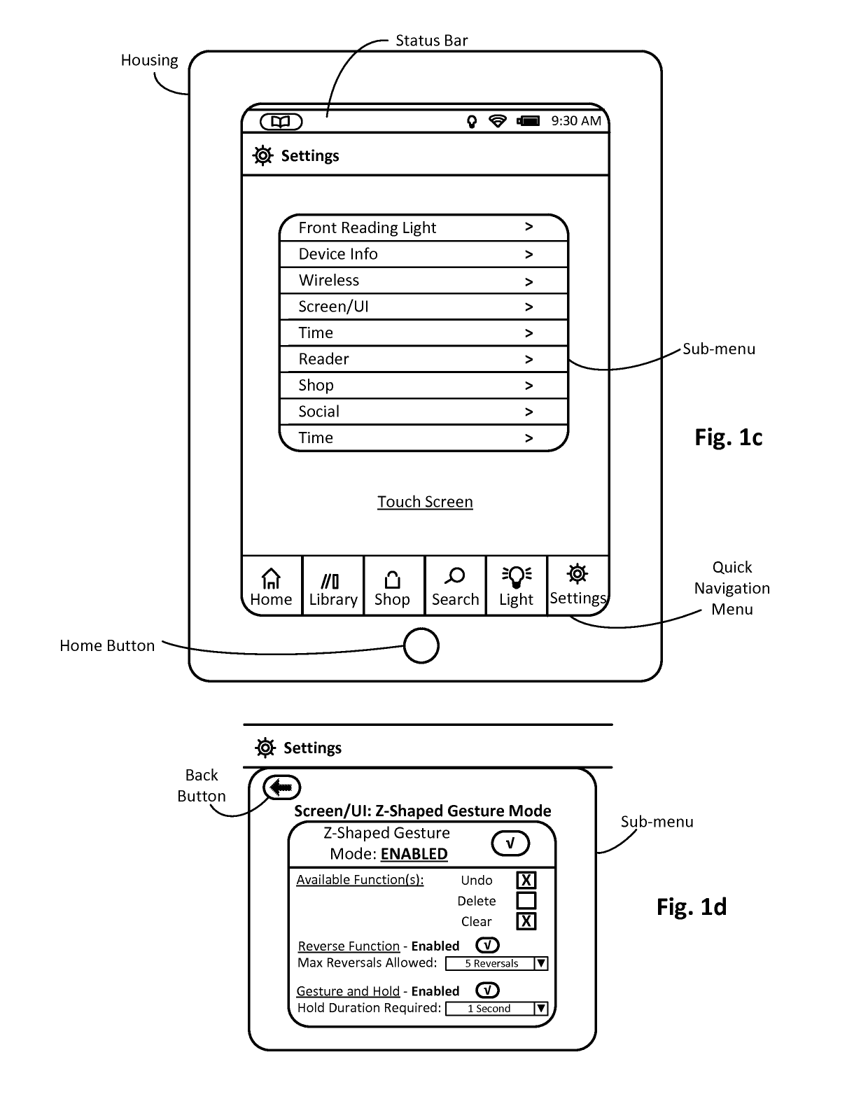

FIGS. 1a-b illustrate an example electronic touch sensitive device having a Z-shaped gesture mode configured in accordance with an embodiment of the present invention. The device could be, for example, a tablet such as the NOOK® Tablet by Barnes & Noble. In a more general sense, the device may be any electronic device having a touch sensitive user interface and capability for displaying content to a user, such as a mobile phone or mobile computing device such as an eReader, a tablet or laptop, a desktop computing system, a television, a smart display screen, or any other device having a touch screen display or a non-touch display screen that can be used in conjunction with a touch sensitive surface. As will be appreciated in light of this disclosure, the claimed invention is not intended to be limited to any particular kind or type of electronic device.

The touch sensitive surface (or touch sensitive display) can be any device that is configured with user input detecting technologies, whether capacitive, resistive, acoustic, active-stylus, and/or other input detecting technology. The screen display can be layered above input sensors, such as a capacitive sensor grid (e.g., for passive touch-based input, such as with a finger or passive stylus in the case of a so-called in-plane switching (IPS) panel), or an electro-magnetic resonance (EMR) sensor grid (e.g., for active stylus-based input). In some embodiments, the touch screen display can be configured with a purely capacitive sensor, while in other embodiments the touch screen display may be configured to provide a hybrid mode that allows for both capacitive input and active stylus input. In still other embodiments, the touch screen display is configured with only an active stylus sensor. Numerous touch screen display configurations can be implemented using any number of known or proprietary screen based input detecting technology. In any such embodiments, a touch screen controller may be configured to selectively scan the touch screen display and/or selectively report contacts detected directly on or otherwise sufficiently proximate to (e.g., within a few centimeters) the touch screen display. Thus, in some such embodiments, the touch screen controller can be configured to interpret inputs from only a capacitive input, only an active stylus input, or both.

As previously explained, the user input may be provided, for example, by a passive implement (e.g., finger or capacitive stylus) or an active stylus, depending on the configuration of the touch screen display. In one example embodiment, an active stylus input can be provided by an actual physical contact on a touch sensitive surface. However, in other embodiments, the active stylus input may involve the stylus hovering some distance above the touch screen display surface (e.g., one to a few centimeters above the surface, or even farther, depending on the sensing technology deployed in the touch screen display), but nonetheless triggering a response at the device just as if direct contact were provided. As will be appreciated in light of this disclosure, an active stylus as used herein may be implemented with any number of active stylus technologies, such as DuoSense® pen by N-trig® (e.g., wherein the active stylus utilizes a touch sensor grid of a touch screen display) or EMR-based pens by Wacom technology, or any other commercially available or proprietary active stylus technology. Further recall that the active stylus sensor in the computing device may be distinct from an also provisioned touch sensor grid in the computing device. Having the touch sensor grid separate from the active stylus sensor grid allows the device to, for example, only scan for an active stylus input, a touch contact, or to scan specific areas for specific input sources, in accordance with some embodiments. In one such embodiment, the active stylus sensor grid includes a network of antenna coils that create a magnetic field which powers a resonant circuit within the active stylus. In such an example, the active stylus may be powered by energy from the antenna coils in the device and the stylus may return the magnetic signal back to the device, thus communicating the stylus' location, angle of inclination, speed of movement, etc. Such an embodiment also eliminates the need for a battery on the stylus.

As can be seen with this example configuration, the device comprises a housing that includes a number of hardware features such as a power button and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to cease an active function that is currently executing on the device, such as a Z-shaped gesture mode as described herein. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device was stowed into a bag or purse, to describe one example physical gesture that would safely put the device to sleep. Thus, in such an example embodiment, the home button may be associated with and control different and unrelated actions: 1) show the quick navigation menu; 2) exit the Z-shaped gesture mode, but keep the page being read or otherwise consumed displayed (e.g., so that another mode can be entered, if so desired); and 3) put the device to sleep. Numerous other configurations and variations will be apparent in light of this disclosure, and the claimed invention is not intended to be limited to any particular set of hardware buttons or features, or device form factor.

As can be further seen, the status bar may also include a book icon (upper left corner). In some such cases, the user can access a sub-menu that provides access to a Z-shaped gesture mode configuration sub-menu by tapping the book icon of the status bar. For example, upon receiving an indication that the user has touched the book icon, the device can then display the Z-shaped gesture mode configuration sub-menu shown in FIG. 1d. In other cases, tapping the book icon just provides bibliographic information on the content being consumed. Another example way for the user to access a Z-shaped gesture mode configuration sub-menu such as the one shown in FIG. 1d is to tap or otherwise touch the Settings option in the quick navigation menu, which causes the device to display the general sub-menu shown in FIG. 1c. From this general sub-menu the user can select any one of a number of options, including one designated Screen/UI in this specific example case. Selecting this sub-menu item (with, for example, an appropriately placed screen tap) may cause the Z-shaped gesture mode configuration sub-menu of FIG. 1d to be displayed, in accordance with an embodiment. In other example embodiments, selecting the Screen/UI option may present the user with a number of additional sub-options, one of which may include a so-called Z-shaped gesture mode option, which may then be selected by the user so as to cause the Z-shaped gesture mode configuration sub-menu of FIG. 1d to be displayed. Any number of such menu schemes and nested hierarchies can be used, as will be appreciated in light of this disclosure.

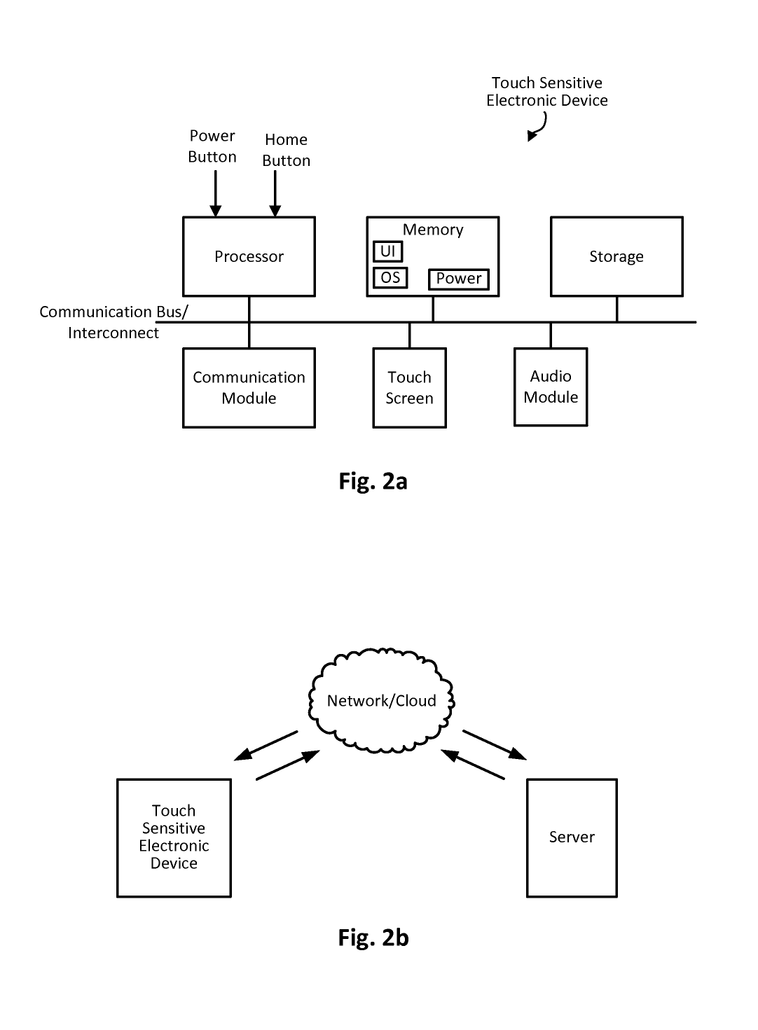

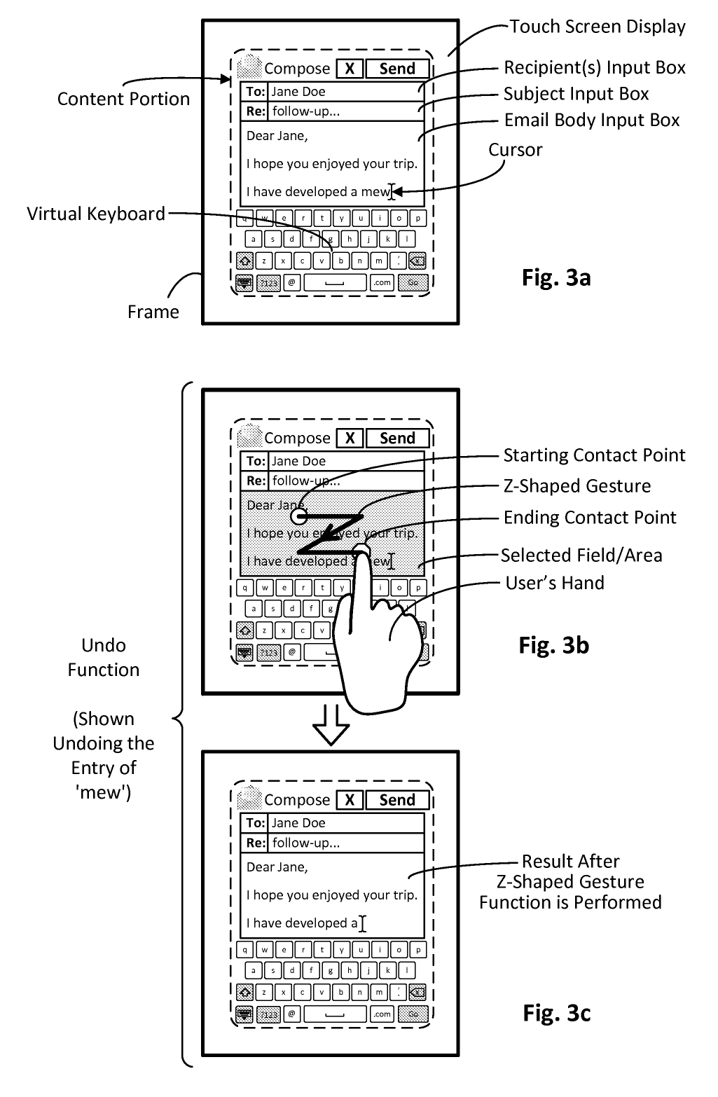

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). Additional example details of the underlying OS and circuitry in accordance with some embodiments will be discussed in turn with reference to FIG. 2a. In some cases, the Z-shaped gesture mode may be automatically configured by the specific UI or application being used. In these instances, the Z-shaped gesture mode need not be user-configurable (e.g., if the Z-shaped gesture mode is hard coded or is otherwise automatically configured).

As previously explained, and with further reference to FIGS. 1c and 1d, once the Settings sub-menu is displayed (FIG. 1c), the user can then select the Screen/UI option. In response to such a selection, the Z-shaped gesture mode configuration sub-menu shown in FIG. 1d can be provided to the user. In this example case, the Z-shaped gesture mode configuration sub-menu includes a UI check box that when checked or otherwise selected by the user, effectively enables the Z-shaped gesture mode (shown in the enabled state); unchecking the box disables the mode. Other embodiments may have the Z-shaped gesture mode always enabled, or enabled by a physical switch or button, for example. In some instances, the Z-shaped gesture mode may be automatically enabled in response to an action, such as when an input box is active or a virtual keyboard is displayed. In some cases, the Z-shaped gesture mode may only be enabled based on selectable content being displayed on the touch screen, or when the displayed content has one or more clearable areas or data fields (e.g., input boxes). As previously described, the user may be able to configure some of the features with respect to the Z-shaped gesture mode, so as to effectively give the user a say in when the Z-mode is available, if so desired.

In the example case shown in FIG. 1d, once the Z-shaped gesture mode is enabled, the user can choose which Available Function(s) are enabled by selecting the corresponding Undo, Delete, and Clear check boxes. As shown, the Undo and Clear functions are selected. Accordingly, these settings would allow a Z-shaped gesture to perform an Undo function and Clear function as described herein, but the Delete function would be unavailable (since it is unselected). The user is also presented with the option of enabling/disabling the Reverse Function feature and the Gesture and Hold feature (both of which are described in more detail herein). As shown, both features are enabled. Any number of features of the Z-shaped gesture mode may be configurable and for purposes of illustration, the settings screen shown in FIG. 1d includes the additional ability to configure the Max Reversals Allowed for the Reverse Function feature (currently set to 5 Reversals) and the ability to configure the Hold Duration Required for the Gesture and Hold feature (currently set to 1 Second). Numerous configurations and features will be apparent in light of this disclosure.

In other embodiments, the user may also specify a number of applications in which the Z-shapes gesture mode can be invoked. Such a configuration feature may be helpful, for instance, in a tablet or laptop or other multifunction computing device that can execute different applications (as opposed to a device that is more or less dedicated to a particular application). In one example case, for instance, the available applications could be provided along with a corresponding check box. Example diverse applications include an eBook application, a photo viewing application, a browser application, a file manager application, a word processor application, a document viewer application, which are just a few examples. In other embodiments, the Z-mode can be invoked whenever the Z-shape gesture is provided in the context of displayed content that can be acted upon (e.g., delete, clear, undo functions), regardless of the application being used. Any number of applications or device functions may benefit from a Z-shaped gesture mode as provided herein, whether user-configurable or not, and the claimed invention is not intended to be limited to any particular application or set of applications.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's physical contact with the surface (e.g., touching the surface with a finger or an implement, such as a stylus) into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc), and encoded on a machine readable medium, that when executed by the processor (and/or co-processors), carries out the functionality of the device including a UI having a Z-shaped gesture mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments® OMAP3621 applications processor), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 6-inch E-ink Pearl 800×600 pixel screen with Neonode® zForce® touch screen, or any other suitable display and touch screen interface technology. The communications module can be, for instance, any suitable 802.11 b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc). The device may be smaller, for example, for smart phone and tablet applications and larger for smart computer monitor and laptop applications.

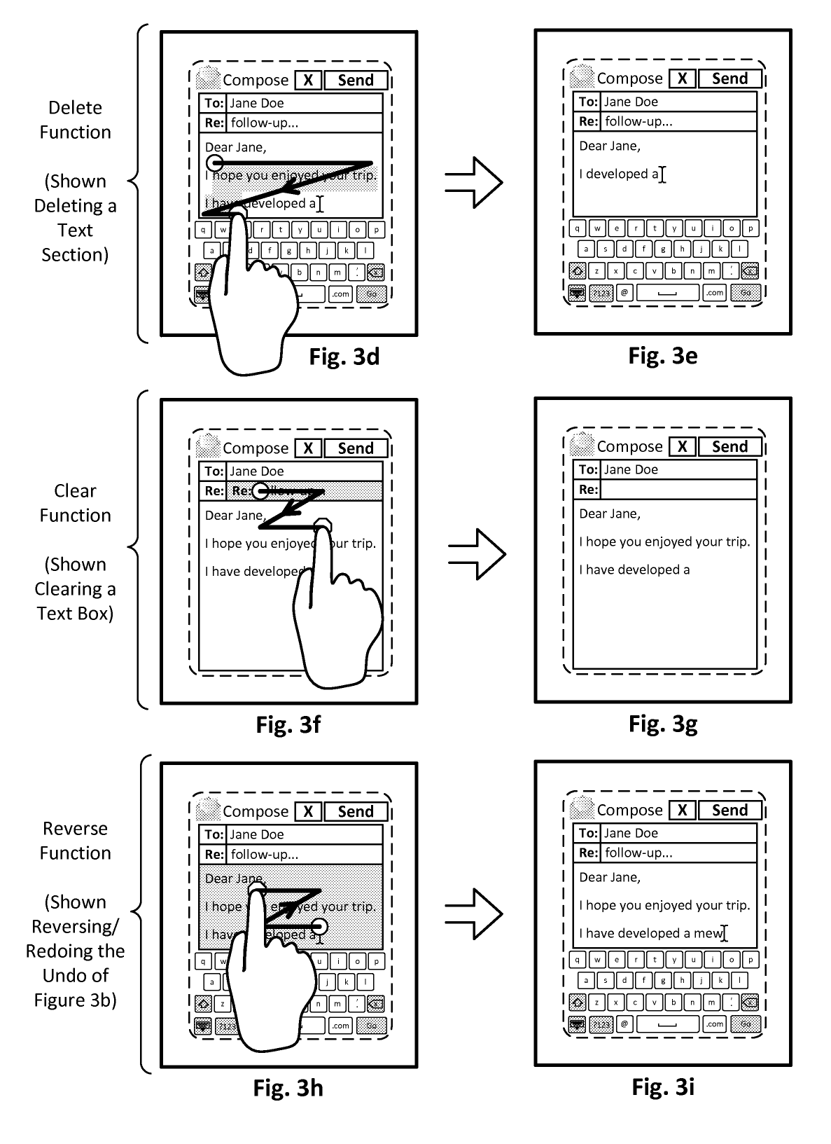

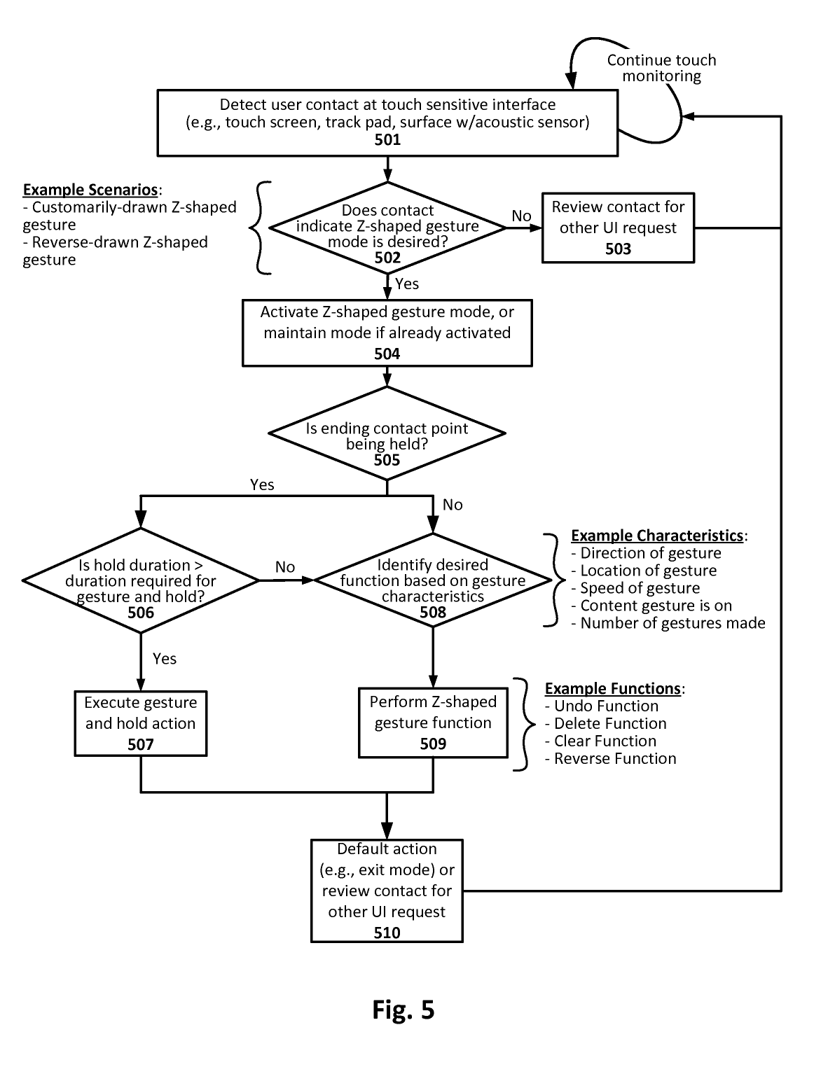

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touch screen technology and the various example screen shots shown in FIGS. 3a-i and 4a-d in conjunction with the Z-shaped gesture mode methodologies demonstrated in FIG. 5, which will be discussed in turn. The audio module can be configured, for example, to speak or otherwise aurally present a selected eBook or other textual content, if preferred by the user. Numerous commercially available text-to-speech modules can be used, such as Verbose text-to-speech software by NCH Software®. In such audio-based cases, note that the navigation function as described herein can be used to identify the textual content to be converted to audio. In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the electronic touch sensitive device of FIG. 2b, configured in accordance with an embodiment of the present invention. As can be seen, the system generally includes an electronic touch sensitive device that is capable of communicating with a server via a network/cloud. In this example embodiment, the electronic touch sensitive device may be, for example, an eBook reader, a mobile cell phone, a laptop, a tablet, desktop, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. Is some such embodiments, the server is configured to remotely provision a Z-shaped gesture mode as provided herein to the touch sensitive device (e.g., via JavaScript or other browser based technology). In other embodiments, portions of the methodology may be executed on the server and other portions of the methodology may be executed on the device. Numerous server-side/client-side execution schemes can be implemented to facilitate a Z-shaped gesture mode in accordance with one or more embodiments, as will be apparent in light of this disclosure.

### Gesture Function Examples

FIGS. 3a-i show screen shots of example Z-shaped gestures that can be applied to a touch sensitive surface of an electronic device and corresponding functions for a Z-shaped gesture mode, in accordance with one or more embodiments of the present invention. As shown in FIG. 3a, the device includes a frame that houses a touch sensitive surface, which in this example, is a touch screen display. In some embodiments, the touch sensitive surface may be separate from the display, such as is the case with a track pad. As previously described, any touch sensitive surface for receiving user input may be used to draw the Z-shaped gestures described herein. The Z-shaped gesture may be drawn by a user's hand or by an implement (such as a pen or stylus), for example. In this example embodiment, the touch screen display contains a content portion (within the dashed line area).

As shown, an application for composing an email is displayed in the content portion. Included in the application are input boxes (e.g., text entry boxes) for indicating the email recipients (To:) and email subject (Re:), and for entering the body of the email. In the example scenario shown in FIG. 3a, the user is editing the body of the email as indicated by the cursor after ‘mew’ in the body input box. As can be further seen, a virtual keyboard is displayed to allow the user to input text or other characters, although in some instances the electronic touch sensitive device may use other input devices, such as a physical keyboard. The content portion depicts other typical features including an email icon and the word ‘Compose’ indicating that a compose email application is being displayed, a button for discarding the draft email (X), and a button for sending the composed email (Send).

The example embodiments shown in FIGS. 3a-i are provided in the context of composing an email for illustrative purposes. However, as will be appreciated in light of this disclosure, the Z-shaped gesture mode may be used with any content displayed on a touch sensitive electronic device, such as any service, application, or software that may use an undo, delete, and/or clear function. Further, the Z-shaped gesture functions are demonstrated individually herein for ease of description. An arrow drawn from one figure to another is used to indicate the relationship between the example Z-shaped gestures (shown in FIGS. 3b, 3d, 3f, and 3h) and the corresponding results after the Z-shaped gesture function is performed (shown in FIGS. 3c, 3e, 3g, and 3i). In some embodiments, the Z-shaped gesture mode may be configured to utilize any combination of undo, delete, and clear functions (and the reversal of those functions) for Z-shaped gestures.

In the example embodiment shown in FIGS. 3b-c, the Z-shaped gesture mode is configured to perform an undo function when a Z-shaped gesture is made. As can be seen in the email body input box in FIG. 3a, the user was trying to type the word ‘new’ but accidentally typed ‘mew’. In this example embodiment, the Z-shaped gesture drawn in FIG. 3b causes an undo function to be performed on the last action (i.e., the entry of the word ‘mew’) and the result of that undo function is shown in FIG. 3c (i.e., the word ‘mew’ has been undone and is no longer in the resulting email body input box). Although the undo function is configured in this example embodiment to undo the action of the previously entered word, the Z-shaped gesture mode may be configured to perform any undo function or use any undo function set known, such as the undo commands used in Microsoft® Word®. Accordingly, the undo function may be applied in any suitable application, such as word processing/text entry boxes (e.g., to undo the last input character, word, sentence, etc.), game applications (e.g., to undo the most recent move), photo applications (e.g., to undo the most recent change), or editing programs (e.g., to undo the most recent edit).

For ease of description, note that the starting contact point is indicated by a circle and the ending contact point is indicated by an octagon, and an arrow on the Z-shape is provided to identify the direction in which the Z-shape was drawn. In some embodiments, the path of the user's gesture and/or the starting contact point may be highlighted in some manner to visually indicate to the user where the Z-shape is being made/drawn.

In this example embodiment, the Z-shaped gesture is configured to perform the undo function in the active input box (i.e., where the user is editing, indicated by the cursor and the presence of the virtual keyboard). Therefore, in this example, the Z-shaped gesture may be drawn anywhere in the content portion. For example, while the user in this particular case provided the Z-shaped gesture on the content of the email, the Z-shaped gesture mode could also have been provided, for instance, on the virtual keyboard to perform the undo function. As will be apparent in light of this disclosure, whether part of the content is active for editing (e.g., whether there is an active input box or page) may control the function performed by the Z-shaped gesture. In this example case, the Z-shaped gesture causes an undo action on the active edit session, and did not need to be directly touching the target content. As previously explained, a quick and arbitrary placement of the Z-shaped gesture can be used for the undo function, while a slower more deliberate Z-shaped gesture can specifically act on the content touched by the Z-shaped gesture.

In some cases, the selected field or area of the display where the Z-shaped gesture function will be performed may be optionally highlighted to assist the user when using the Z-shaped gesture mode. The mode may be configured such that the highlighting occurs while the gesture is being drawn (e.g., after a starting contact point has been initiated and the Z-shaped gesture is in process, but before the ending contact point has been released). In this example embodiment, the Z-shaped gesture function is being performed in the active email body input box and that box is highlighted as shown to indicate the location where the undo function will be performed. In some instances, the Z-shaped gesture may be canceled mid-gesture by drawing back to the starting contact point (e.g., choosing an ending contact point on or very close in proximity to the starting contact point).

In the example screen shots shown in FIGS. 3d-e, an embodiment of the Z-shaped gesture mode is configured to perform a specific delete function when a Z-shaped gesture is made. As can be seen in FIG. 3d, the user has drawn a Z-shaped gesture to delete the words between the start and stop points of the Z-gesture. In this example case, the content selected by the Z-shaped gesture is highlighted, but it need not be in all embodiments. When the Z-shaped gesture mode is configured to perform a delete function, the location of the Z-shaped gesture may be relevant to indicate what content should be deleted. For example, in this embodiment, the starting contact point is being used to control where the deletion section should start and the ending contact point is being used to determine where the deletion section should end. Such a thoughtful and carefully placed Z-shaped gesture would likely be drawn slower than a relatively fastly and arbitrarily drawn undo Z-shaped gesture. In this manner, the starting and ending contact points of the Z-shaped gesture and/or the speed of the gesture control the performed function. The result of the specific deletion made by the Z-shaped gesture in FIG. 3d is shown in FIG. 3e.

In the example screen shots shown in FIGS. 3f-g, an embodiment of the Z-shaped gesture mode is configured to perform a clear function when a Z-shaped gesture is made. As can be seen in FIG. 3f, the user has drawn a Z-shaped gesture on the subject box to clear the contents of that box. The Z-shaped gesture mode may be configured to perform the clear function, for example, when the Z-shaped gesture is drawn over the content being cleared, or the Z-shaped gesture begins inside a target content field to be cleared, or the Z-shaped gesture otherwise passes through the target content field to be cleared. In the example of FIG. 3f, the Z-gesture begins in the subject box and concludes in the body portion of the email. The initial touch point of the Z-gesture sitting in the subject box can be used to identify the user's intent to clear that box, as shown in FIG. 3g. To this end, note that in some embodiments, the dwell time of the initial touch point of the Z-gesture can be used to identify target content or a target field.

In the example shown in FIGS. 3h-i, an embodiment of the Z-shaped gesture mode is configured to perform a reverse function when a Z-shaped gesture is made. As previously disclosed, the direction that the Z-shaped gesture is drawn may be used to control the function performed. In the previous example embodiments shown in FIGS. 3b-g, a Z-shaped gesture drawn from the top-left to the bottom-right was used to perform an undo, delete, or clear function. In the example embodiment shown in FIG. 3h, the Z-shaped gesture mode is configured to allow reverse-drawn Z-shaped gestures (i.e., from the bottom-right to the top-left of the Z-shape or where the starting contact point is below the ending contact point) to reverse one or more previously performed undo, delete, or clear functions. Therefore, the reverse function is dependent on an undo, delete, or clear function being first performed to be able to reverse that undo/delete/clear function.

Continuing with the example embodiment shown in FIG. 3h, a reverse-drawn Z-shaped gesture is being drawn to reverse the undo performed in FIG. 3b. In this example, the undo of the entry of the word ‘mew’ is being reversed, such that the word ‘mew’ is re-entered as shown in FIG. 3i. In instances where the delete and clear functions can be reversed, the reverse function un-deletes or un-clears the content that was deleted or cleared, respectively. The Z-shaped gesture mode may be configured to allow a set number of reverses or as many reverses as possible. In addition, in some cases, the Z-shaped gesture mode may be configured to reverse previous functions even where the functions were different (i.e., a mixture of undo, delete, and clear functions). In these cases, the Z-shaped gesture performing the reverse function would reverse the most recent undo, delete, or clear function and work backwards chronologically. For example, if the Z-shaped gesture in FIG. 3d was drawn and then the Z-shaped gesture in FIG. 3f was drawn to perform the respective deletion and clear functions, a first reverse-drawn Z-shaped gesture may be drawn to undo the clear function (the most recent function) and then a second reverse-drawn Z-shaped gesture may be drawn to undo the deletion function.

As previously described, different characteristics of the Z-shaped gesture may control the function performed. The examples above provide some illustrations of how the placement/location, speed, dwell time, and/or drawing direction of the Z-shaped gesture may control the function performed. In addition, embodiments of the Z-shaped gesture mode may be configured such that other characteristics of the Z-shaped gestures may control the function performed, such as the size of the drawing or the number of fingers used when drawing. For example, the Z-shaped gesture mode may be configured such that the size and/or number of starting contact points used (such as number of fingers used) when drawing a Z-shaped gesture as described herein controls the function performed or the scope of the function performed. As a more specific example, in one embodiment, the mode may be configured such that a one-finger Z-gesture is used to delete content (e.g., as shown in FIGS. 3d-e), a two-finger Z-gesture is used to undo an action (e.g., as shown in FIGS. 3b-c), and a three-finger Z-gesture is used to clear a content field.

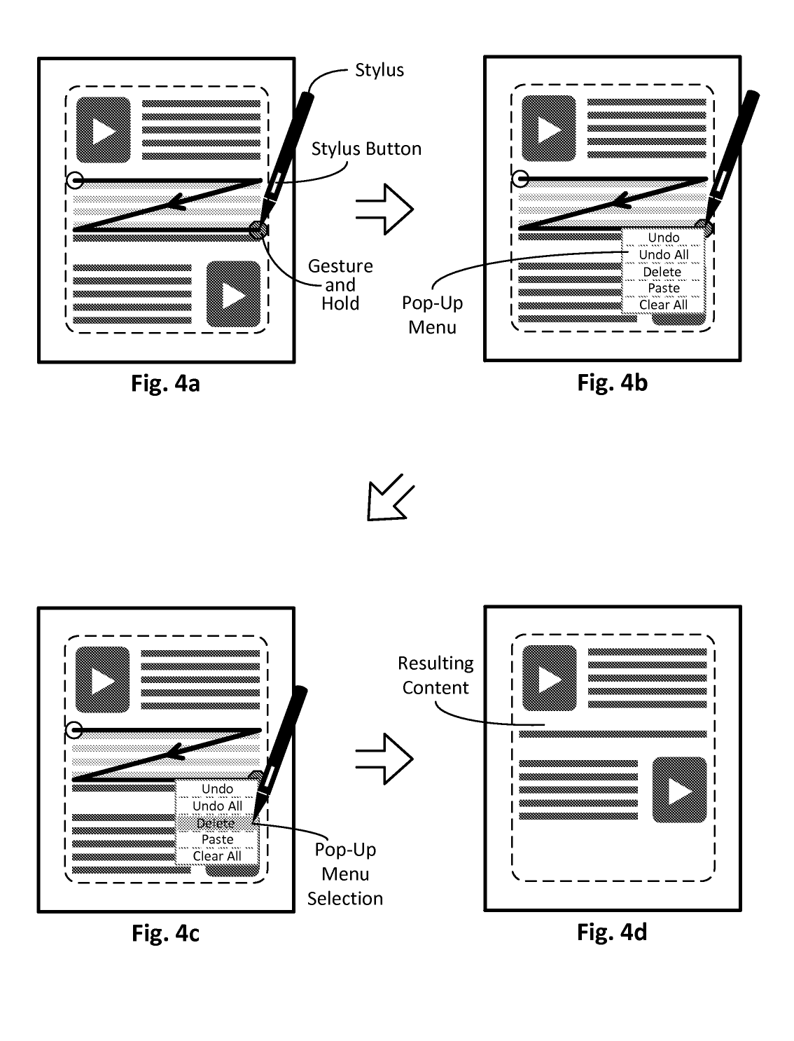

FIGS. 4a-d show screen shots of a Z-shaped gesture mode configured with a gesture and hold feature, in accordance with an embodiment of the present invention. In some instances, the Z-shaped gesture mode may be configured to have a gesture and hold feature where a user can draw a Z-shaped gesture and hold the ending contact point to perform an action. In some configurations, only one action is performed after a hold duration time has elapsed. In other configurations, different durations of the hold may result in different actions. For example, the mode may be configured such that holding for a first duration undoes the last action, holding for a second duration undoes the last two actions, holding for a third duration undoes the last five actions, and holding for a fourth duration undoes all previous actions.

Turning to FIG. 4a, the Z-shaped gesture and hold is shown. As was previously described, the Z-shaped gestures disclosed herein can be made in various ways using touch sensitive electronic devices. In this case, the Z-shaped gesture is drawn using a stylus as shown. However, as previously described, a user may draw the Z-shaped gesture using one or more fingers or a different implement, for example. The stylus is equipped with a stylus button that may be used to activate one or more of the functions or features described herein, such as a reverse function or a gesture and hold action. The Z-shaped gesture mode may be configured such that other implement control features activate one or more of the functions or features described herein. The speed of the gesture or number of contact points may also activate one or more of the functions or features described herein. For example, the Z-shaped gesture mode may be configured such that when a user makes a Z-shaped gesture using two or more contact points (such as two fingers), the gesture and hold action is automatically performed regardless of the duration that the ending contact point is held.

Continuing with the example shown in FIG. 4a, the ending contact point of the drawn Z-shaped gesture is filled-in to indicate that the ending contact point was held for a required duration of time (e.g., 1-3 seconds, which may be user-configurable). The Z-shaped gesture mode may be configured to provide visual, audio, or some other feedback, such as haptic feedback (e.g., a vibration) to indicate to the user that the ending contact point has been held long enough to trigger/activate the gesture and hold feature. In this example case, the feedback is visual, i.e., the ending contact point is displayed as filled-in since the ending contact point was held for the duration of time required to trigger/activate the gesture and hold feature.

The Z-shaped gesture mode may be configured to perform numerous different actions upon the triggering/activation of the gesture and hold feature. For example, the gesture and hold feature may be configured to perform a duration dependent action, as previously described. The action(s) performed by the gesture and hold feature may be user-configurable (e.g., from a settings menu such as that shown in FIG. 1d), hard-coded, or some combination thereof. In the example embodiment shown in FIG. 4b, the Z-shaped gesture and hold action performed over content in a content editing application results in a pop-up menu (or context menu) being presented from the ending contact point of the Z-shaped gesture drawn. The pop-up menu presents different selectable options: Undo (undo last action), Undo All (undo all actions), Delete (delete selected area), Paste (paste in place of selected area), and Clear All (clear input box or content). In other configurations, the pop-up menu may present different options, such as a Reverse option (reverse the last undo, delete, or clear function). The pop-up menu options may be user-configurable, hard-coded, or some combination thereof (e.g., a user can customize two of the five slots in the drop down menu).

Continuing from FIG. 4b, FIG. 4c shows the user selecting the Delete function option to delete the selected area. In some instances, the user may be required to maintain contact in order to select the desired option (i.e., the pop-up menu disappears upon contact release), while in other instances, the user may be able to release contact before selecting the desired option. The result of selecting the Delete function option to delete the content drawn over by the Z-shaped gesture is shown in FIG. 4d. In some embodiments, the Z-shaped gesture mode may be configured to have additional features to enhance the user experience, such as providing haptic feedback (e.g., the electronic device vibrates) or an audio notification (e.g., a sound) after a Z-shaped gesture undo, delete, clear, or reverse function has been performed. Numerous different Z-shaped gestures and configurations will be apparent in light of this disclosure.

Methodology

FIG. 5 illustrates a method for providing a Z-shaped gesture mode in an electronic touch sensitive device, in accordance with an embodiment of the present invention. This example methodology may be implemented, for instance, by the UI module of the touch sensitive device shown in FIG. 2a, or the touch sensitive device shown in FIG. 2b (e.g., with the UI provisioned to the client by the server). To this end, the UI can be implemented in software, hardware, firmware, or any combination thereof, as will be appreciated in light of this disclosure.

As can be seen, the method generally includes sensing a user's input by a touch sensitive surface. In general, any touch sensitive device may be used to detect contact with it by one or more fingers and/or styluses or other suitable implements. As soon as the user begins to drag or otherwise move the contact point(s) (i.e., starting contact point(s)), the UI code (and/or hardware) can assume a drag gesture has been engaged and track the path of each contact point with respect to any fixed point within the touch surface until the user stops engaging the touch sensitive surface (i.e., ending contact point(s)). The release point can also be captured by the UI as it may be used to commit the action started when the user pressed on the touch sensitive surface. In a similar fashion, if the user releases hold without moving the contact point, a gesture and hold command may be assumed depending on the amount of time the user was continually pressing on the touch sensitive surface. These main detections can be used in various ways to implement UI functionality, including a Z-shaped gesture mode as variously described herein, as will be appreciated in light of this disclosure.

In this example case, the method includes detecting 501 user contact at the touch sensitive interface. In general, the touch monitoring is effectively continuous. The method continues with determining 502 if the contact indicates that a Z-shaped gesture mode is desired. As previously explained, this desire may be communicated by, for example, a customarily drawn Z-shaped gesture (i.e., from the top-left to the bottom-right of the Z-shape or where the starting contact point is above the ending contact point) or a reverse-drawn Z-shaped gesture (i.e., from the bottom-right to the top-left of the Z-shape or where the starting contact point is below the ending contact point). In this sense, the UI can readily detect a Z-shaped gesture. In one example case, the acute angles inherent in a Z-shaped gesture, or even just the first of the first acute angles, can be detected to affirmatively identify that the Z-shape gesture mode is desired. Embodiments of the Z-shaped gesture mode may be configured to account for variation in making the Z-shaped gesture. For example, the variation allowed in the first and second near horizontal lines may be set to such that off-horizontal lines are captured within a certain degree range, such as +/−1°, 2°, 5°, 10°, 15°, 20°, 30°, 45° from horizontal (relative to the content displayed on the electronic device). In addition, in some instances, the Z-shaped gesture mode can be configured to account for other variations in made Z-shaped gestures to appropriately capture when the user is indicating the Z-shaped gesture mode is desired. For example, the Z-shaped gesture mode may be configured to recognize backwards drawn Z-shaped gestures (similar to S-shaped gestures) and perform the appropriate undo, clear, delete, or reverse function as though a regular Z-shaped gesture had been drawn. In any case, if the contact does not indicate that the Z-shaped gesture mode is desired, then the method may continue with reviewing 503 the contact for some other UI request (e.g., select a file, send an email, etc). On the other hand, if the contact does indicate that the Z-shaped gesture mode is desired, the method continues with activating 504 the Z-shaped gesture mode, or otherwise maintaining the mode if already activated.

The method continues with identifying 505 whether the ending contact point is being held after a Z-shaped gesture is made/drawn. If the ending point is being held, the method determines 506 whether the hold duration is greater than the duration required for a Z-shaped gesture and hold feature. For example, when the gesture and hold feature is enabled, the hold duration required may be configured through the UI settings. In some instances, the gesture and hold feature may have more than one set durations that correspond to different actions, such as hold for one second to delete the most recently entered word, hold for two seconds to delete the most recently entered sentence, hold for three second to delete the most recently entered paragraph, etc. In any such example cases, if the duration is greater than the duration required for the gesture and hold feature, then the method executes 507 the gesture and hold action (e.g., displaying a pop-up menu as shown in FIGS. 4a-d). In some embodiments, the executed action may be to perform a particular undo, delete, clear, or reverse function.

If the ending contact point is not being held or the Z-shaped gesture and hold duration is less than the duration required to trigger the gesture and hold feature, then the method continues with identifying 508 the desired function based on the characteristics of the Z-shaped gesture. The characteristics may include the direction the Z-shaped gesture is made, the location of the starting and/or ending contact points (including the content the Z-shaped gesture is being drawn on/over/in), the number of starting contact points (i.e., the number of Z-shaped gestures being simultaneously drawn, such as the number of fingers making the gesture), and the speed of the Z-shaped gesture. Recall that the mode may be configured by the user to a given extent, in some embodiments. Other embodiments, however, may be hard-coded or otherwise configured to carry out certain specific actions without allowing for user configuration, as will be further appreciated in light of this disclosure.

The method continues with performing 509 the corresponding Z-shaped gesture function based on the Z-shaped gesture previously identified at 508. As previously described, the corresponding function may be one of an undo, delete, or clear function, or, where one of those functions was previously performed, a reverse function to reverse the previously performed undo, delete, or clear function. The function performed may be any variation of these four functions, such as an undo all function, a delete paragraph function, a clear the entire input box function, or a reverse previous five undo action functions (i.e., perform five redo functions). After the gesture and hold feature action is executed 507 or the Z-shaped gesture function is performed 509, then the method continues with a default action 510, such as exiting the Z-shaped gesture mode or doing nothing until further user contact/input is received. Likewise, the received contact can be reviewed for some other UI request, as done at 503. The method may continue in the touch monitoring mode indefinitely or as otherwise desired, so that any contact provided by the user can be evaluated for use in the Z-shaped gesture mode if appropriate. As previously indicated, the Z-shaped gesture mode may be configured to be exited by, for example, the user releasing the ending contact point or pressing a release mode UI feature such as the home button or a touch screen feature.

Numerous variations and embodiments will be apparent in light of this disclosure. One example embodiment of the present invention provides a device including a display for displaying content to a user, a touch sensitive surface for allowing user input (e.g., through direct and/or proximate contact with the touch sensitive surface), and a user interface including a Z-shaped gesture mode configured to perform at least one of an undo, a delete, and a clear function in response to user input including a Z-shaped gesture. In some cases, the display is a touch screen display that includes the touch sensitive surface. In some instances, the user input including the Z-shaped gesture is direct contact on the touch sensitive surface. In some cases, the Z-shaped gesture mode is configured to additionally perform a reversal function that reverses the at least one undo, delete, and clear function. In some instances, the function performed in response to the Z-shaped gesture is based on the direction, speed, and/or number of input points used to make the Z-shaped gesture. In some cases, the function performed in response to the Z-shaped gesture is based on the content over which the Z-shaped gesture is made. In some instances, the Z-shaped gesture is made by one of a user's physical touch and a stylus. In some cases, the Z-shaped gesture mode is user-configurable. In some instances, the device is an eReader device or a tablet computer or a smart phone.

Another embodiment of the present invention provides an electronic device including a display having a touch screen interface and for displaying content to a user, and a user interface including a Z-shaped gesture mode configured to perform at least one of an undo, a delete, and a clear function in response to user input, the user input including a starting input point, a Z-shaped gesture, and an ending input point, wherein at least one of the starting input point and the ending input point controls the desired action to be performed. In some cases, the Z-shaped gesture mode further includes a reversal function configured to reverse a previously performed undo, delete, and/or clear function. In some instances, the Z-shaped gesture mode is configured to perform at least one of an undo, a delete, and a clear function when the Z-shaped gesture has a starting input point above the ending input point and is further configured to perform a reversal function when the Z-shaped gesture has a starting input point below the ending input point. In some cases, the user input including the starting input point, Z-shaped gesture, and ending input point is made in one continuous gesture. In some instances, the Z-shaped gesture mode further includes a gesture and hold feature that executes at least one action when the ending input point is held for a duration greater than a required minimum. In some cases, the gesture and hold feature executes two or more actions based on the duration of the hold, the actions including specific functions to perform.

Another embodiment of the present invention provides a computer readable medium encoded with instructions that when executed by one or more processors, cause a process to be carried out. The process includes, in response to user input via a touch sensitive interface of a device capable of displaying content, activating a Z-shaped gesture mode in the device, the user input including a Z-shaped gesture, wherein the user input indicates a desired function including at least one of an undo, delete, and clear function, and executing the desired function. In some cases, the desired function further includes a reversal function configured to reverse a previously performed undo, delete, and/or clear function. In some instances, the desired function performed is controlled by the characteristics of the user input, the characteristics including at least one of the content displayed in the location of the Z-shaped gesture, the starting and/or ending input points of the Z-shaped gesture, the direction of the Z-shaped gesture, the speed of the Z-shaped gesture, the amount of starting input points used for the Z-shaped gesture, and the size of the Z-shaped gesture. In some cases, the Z-shaped gesture is one continuous gesture of a first near horizontal line connected to the opposite side of a second near horizontal line. In some instances, the process further includes the step of providing feedback to indicate when the desired function is initiated and/or completed.

As used herein in the specification and claims, the term “and/or,” when used in a list of two or more items, means that any one of the listed items can be employed by itself, or any combination of two or more of the listed items can be employed. For example, if a function is described as being based on A, B, and/or C, the function can be based on: A alone; B alone; C alone; A and B in combination; A and C in combination; B and C in combination; or A, B, and C in combination.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive surface for allowing user input; and
a user interface including a Z-shaped gesture mode configured to perform at least one of an undo, a delete, and a clear function in response to user input including a Z-shaped gesture.

2. The device of claim 1 wherein the display is a touch screen display that includes the touch sensitive surface.

3. The device of claim 1 wherein the user input including the Z-shaped gesture is direct contact on the touch sensitive surface.

4. The device of claim 1 wherein the Z-shaped gesture mode is configured to additionally perform a reversal function that reverses the at least one undo, delete, and clear function.

5. The device of claim 4 wherein the function performed in response to the Z-shaped gesture is based on the direction, speed, and/or number of input points used to make the Z-shaped gesture.

6. The device of claim 1 wherein the function performed in response to the Z-shaped gesture is based on the content over which the Z-shaped gesture is made.

7. The device of claim 1 wherein the Z-shaped gesture is made by one of a user's physical touch and a stylus.

8. The device of claim 1 wherein the Z-shaped gesture mode is user-configurable.

9. The device of claim 1 wherein the device is an eReader device or a tablet computer or a smart phone.

10. An electronic device, comprising:
a display having a touch screen interface and for displaying content to a user; and
a user interface including a Z-shaped gesture mode configured to perform at least one of an undo, a delete, and a clear function in response to user input, the user input including a starting input point, a Z-shaped gesture, and an ending input point;
wherein at least one of the starting input point and the ending input point controls the desired action to be performed.

11. The device of claim 10 wherein the Z-shaped gesture mode further includes a reversal function configured to reverse a previously performed undo, delete, and/or clear function.

12. The device of claim 11 wherein the Z-shaped gesture mode is configured to perform at least one of an undo, a delete, and a clear function when the Z-shaped gesture has a starting input point above the ending input point and is further configured to perform a reversal function when the Z-shaped gesture has a starting input point below the ending input point.

13. The device of claim 10 wherein the user input including the starting input point, Z-shaped gesture, and ending input point is made in one continuous gesture.

14. The device of claim 10 wherein the Z-shaped gesture mode further includes a gesture and hold feature that executes at least one action when the ending input point is held for a duration greater than a required minimum.

15. The device of claim 14 wherein the gesture and hold feature executes two or more actions based on the duration of the hold, the actions including specific functions to perform.

16. A computer readable medium encoded with instructions that when executed by one or more processors, cause a process to be carried out, the process comprising:
in response to user input via a touch sensitive interface of a device capable of displaying content, activating a Z-shaped gesture mode in the device, the user input including a Z-shaped gesture, wherein the user input indicates a desired function including at least one of an undo, delete, and clear function; and
executing the desired function.

17. The computer readable medium of claim 16 wherein the desired function further includes a reversal function configured to reverse a previously performed undo, delete, and/or clear function.

18. The computer readable medium of claim 16 wherein the desired function performed is controlled by the characteristics of the user input, the characteristics including at least one of the content displayed in the location of the Z-shaped gesture, the starting and/or ending input points of the Z-shaped gesture, the direction of the Z-shaped gesture, the speed of the Z-shaped gesture, the amount of starting input points used for the Z-shaped gesture, and the size of the Z-shaped gesture.

19. The computer readable medium of claim 16 wherein the Z-shaped gesture is one continuous gesture of a first near horizontal line connected to the opposite side of a second near horizontal line.

20. The computer readable medium of claim 16, the process further comprising the step of providing feedback to indicate when the desired function is initiated and/or completed.
